(19) United States
(12) Patent Application Publication
(10) Pub. No.: US 2008/0273744 A1
(43) Pub. Date: Nov. 6, 2008

(54) DIGITAL WATERMARKING METHOD AND APPARATUS

(75) Inventors: Nakaba Kogure, Zama-shi (JP); Noboru Yamaguchi, Yashio-shi (JP); Tomoo Yamakage, Yokohama-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 11/946,129

(22) Filed: Nov. 28, 2007

(30) Foreign Application Priority Data
Nov. 30, 2006 (JP) 2006-324469

(51) Int. Cl. G06K 9/00

(52) U.S. Cl. 382/100

(57) ABSTRACT

A digital watermark embedding apparatus including a first scaling unit to scale an input image signal to one of enlargement and reduction, an extraction unit extracting a specific frequency component signal from the scaled image signal, a digital watermark signal generator to generate a digital watermark signal based on the specific frequency component signal and watermark information, a second scaling unit to scale the digital watermark signal to the other of the enlargement and reduction, and a compositor to combine the scaled digital watermark signal with the input image signal to generate a watermarked image signal.

### CROSS-REFERENCE TO RELATED APPLICATIONS

This application is based upon and claims the benefit of priority from prior Japanese Patent Application No. 2006-324469, filed Nov. 30, 2006, the entire contents of which are incorporated herein by reference.

### BACKGROUND OF THE INVENTION

1. Field of the Invention

The present invention relates to a digital watermarking method suitable for preventing unauthorized copying of a digital video provided through, for example, a recording medium, and an apparatus for the same.

2. Description of the Related Art

Since apparatuses for recording and playing back digital image data such as digital VTRs or DVDs (digital versatile disks) have been spread, many digital video images capable of being played back with these apparatuses are provided. Further, various digital video images are distributed by digital television broadcast through Internet, broadcasting satellite, a communication satellite and so on, resulting in that a user can use a high quality digital video image.

The digital video image makes it possible to create a high quality copy at a digital signal level simply. Accordingly, the digital video image might be copied without any restriction if some playback prohibition or playback control is done. Accordingly, there is explored a method of adding information for controlling copying to a digital video image in order to prevent unauthorized copying of the digital video image or control the generation number of copies done by an authorized user, and preventing unauthorized copying or restricting the copy by using the additional information.

As a technique for overlapping another additional information on the digital video image as described above, a digital watermarking is known. The digital watermarking is a technique for embedding, in the contents such as digitalized speech, music, video images and still images, information (called watermark information) such as identification information of a copyright holder of the contents and a user thereof, right information of the copyright holder, a utilization condition of the contents, and secret information needed at the time of the utilization of the contents or information such as copying control information described above, performing copyright protection including utilization control and copying control by detecting watermark information from the contents if needed, and promoting the secondary utilization.

Various techniques are proposed for a digital watermark system. A system utilizing a spectrum diffusion technique is known as the digital watermark system. This system embeds watermark information in a digital video image according to the following procedure.

The step E1 carries out a spread spectrum by multiplying a PN (Pseudorandom Noise) sequence by an image signal.

The step E2 performs frequency transformation (for example, DCT) on the image signal subjected to the spread spectrum.

The step E3 embeds watermark information by changing a value of a specific frequency component.

The step E4 performs an inverse frequency transform (for example, IDCT) on the image signal.

The step E5 performs an inverse spread spectrum on the image signal (by multiplying the image signal by the PN sequence identical with that of the step E1).

On the other hand, watermark information is detected from the digital video image in which watermark information is embedded, according the following procedure.

The step D1 carries out a spread spectrum by multiplying the image signal by the PN (Pseudorandom Noise) sequence (PN sequence identical with that of step E1).

The step D2 performs frequency transformation (for example, DCT) on the image signal subjected to the spread spectrum.

The step D3 extracts embedded watermark information by paying attention to the value of the specific frequency component.

On the other hand, as one of watermarking technologies suitable for a video image is proposed a technique of producing a watermark signal using a specific frequency component signal extracted from the to-be-watermarked image signal and embedding the watermark signal in a to-be-watermarked image signal. When the digital watermark signal embedded by this method is detected, the digital watermark signal is detected by extracting a specific frequency component signal similar to the specific frequency component signal used on the watermark embedding side from the watermarked image signal on the detection side.

When the digital watermark is used for preventing unauthorized utilization, it is necessary to have the property (robustness) that watermark information is not vanished or tampered by various operations and intentional attack assumed to be subjected to a digital copyrighted work conventionally. Cutting out of image, scaling (enlargement/reduction), etc. are considered as attacks which make it impossible to detect watermark information from the digital image in which the watermark information is embedded.

When the image suffered such an attack is input, in a conventional art using a spread spectrum technique, at first the PN sequence used in embedding step E1 at the time of detection of the watermark information is estimated, and the embedded watermark information is extracted by executing steps D1 to D3 after restoration of synchronization of the PN sequence. In this case, there is a problem that since the watermark information weakens in the image suffered the attack, the watermark information cannot be detected even if watermark detection corresponding to the attack is done.

On the other hand, the technique of embedding in a to-be-watermarked image signal a digital watermark signal generated based on a specific frequency component extracted from the to-be-watermarked image signal and detecting the digital watermark signal based on the specific frequency component signal extracted from the watermarked image signal as described in JP-A 2002-325233 (KOKAI) has basically a high robust against the attack such as cutting out of the image or scaling. However, there is room for improvement about the robust against the scaling attack with large resizing such as resizing from the screen size of the High Definition Television (HDTV) to the screen size of Standard Definition Television (SDTV).

In other words, when the screen size is largely resized, the frequency band in which the digital watermark signal is embedded on the embedding side largely differs from the frequency band from which the digital watermark signal is extracted on the detection side, resulting in that the energy of the specific frequency component signal extracted on the detection side deteriorates and the detection performance of the digital watermark deteriorates. As a result, the robust against the scaling attack weakens.

The object of the present invention is to provide a digital watermarking method having a high robust against the scaling attack by which the screen size largely differs between the embedding of the digital watermark and the detection thereof when detecting the digital watermark by extracting the specific frequency component signal on the detection side.

### BRIEF SUMMARY OF THE INVENTION

An aspect of the invention provides a digital watermark embedding method comprising: scaling an input image signal to one of enlargement and reduction; extracting a specific frequency component signal from the scaled image signal; generating a digital watermark signal based on the specific frequency component signal and watermark information; scaling the digital watermark signal to the other of the enlargement and reduction; and combining the scaled digital watermark signal with the input image signal to generate a watermarked image signal.

### BRIEF DESCRIPTION OF THE SEVERAL VIEWS OF THE DRAWING

FIG. 1 is a block diagram illustrating a digital watermarking apparatus according to one embodiment.

FIG. 2 is a block diagram illustrating an operative example of a watermark signal generator shown in FIG. 1.

FIG. 3 is a flow chart showing a digital watermarking procedure concerning the embodiment.

FIG. 4 is a block diagram illustrating a digital watermark detection apparatus according to the embodiment.

FIG. 5 is a diagram of explaining a phase shift of a specific frequency component signal, which is performed with a phase controller.

FIG. 6 is a diagram showing an operation example of peak search of correlation value and watermark information detection in the digital watermark detection apparatus of FIG. 1.

FIG. 7 is a diagram illustrating wave forms at respective parts of the digital watermarking apparatus of FIG. 1.

FIG. 8 is a diagram illustrating wave forms at respective parts of the digital watermark detection apparatus of FIG. 4.

FIG. 9 is a diagram showing an operation of searching for the peak of a correlation value and detecting the watermark information when the watermark information in the digital watermark detection apparatus of FIG. 4 indicates (1,1).

FIG. 10 is a diagram showing an operation of searching for the peak of a correlation value and detecting the watermark information when the watermark information in the digital watermark detection apparatus of FIG. 4 indicates (1,−1).

FIGS. 11A to 11C are diagrams illustrating concept of watermarking/detection when suffering a scaling attack.

FIGS. 12A to 12C are diagrams illustrating concept of the watermarking/detection according to the embodiment.

FIG. 13 is a block diagram illustrating a digital watermarking apparatus according to another embodiment.

### DETAILED DESCRIPTION OF THE INVENTION

(About a Digital Watermarking Apparatus)

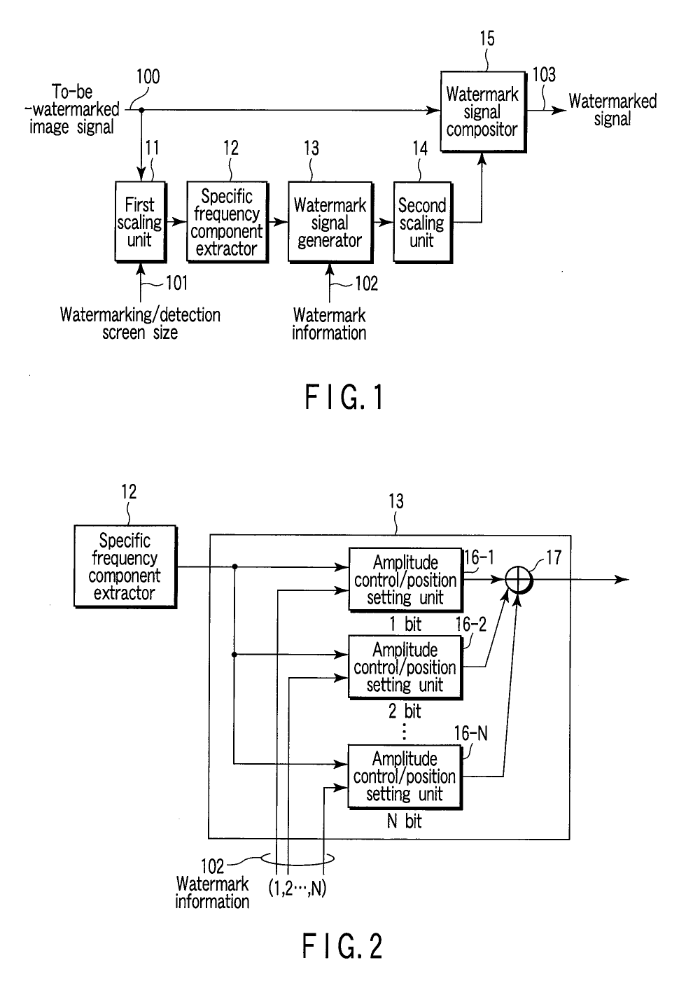

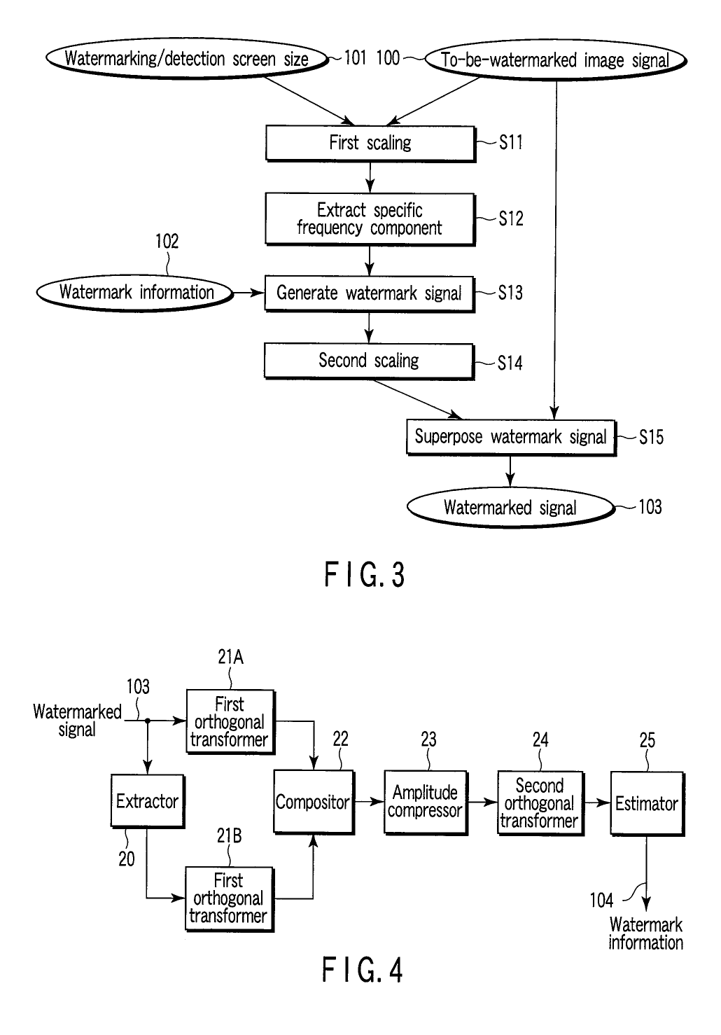

As shown in FIG. 1, the digital watermarking apparatus according to one embodiment comprises a first scaling unit (enlargement/reduction unit) 11, a specific frequency component extractor 12, a watermark signal generator 13, a second scaling unit 14, and a watermark signal compositor 15. FIG. 2 shows details of the signal generator 13, and FIG. 3 shows a routine of processing of the digital watermarking apparatus of FIG. 1.

There will be described the digital watermarking apparatus according to the embodiment in conjunction with FIGS. 1 and 3. For example, a digital image signal of a motion video or a still video is input to the digital watermarking apparatus as an input image signal (referred to as a to-be-watermarked image signal) 100. The to-be-watermarked image signal 100 may include both of a luminance signal and a color-difference signal, but it may be only a luminance signal. The to-be-watermarked image signal 100 and watermarking/detection screen size information 101 are input to the scaling unit 11 and the signal compositor 15.

The first scaling unit 11 scales (enlarges or reduces) the to-be-watermarked image signal 100 based on the watermarking/detection screen size information 101 so that the difference between the watermarking screen size and the detection screen size is smaller than or equal to a threshold (step S11). For example, if the watermarking screen size is a HDTV size, and the detection screen size is a SDTV size, the first scaling unit 11 reduces the to-be-watermarked image signal 100 from the HDTV size to the SD TV size. The HDTV size means a screen size of HDTV, and the SDTV size means a screen size of the SDTV.

As well known, the SDTV is a system used in the current analog ground wave broadcast, and 480i, 480p are referred to as SDTV. The SDTV displays an image by 525 scanning lines, whereas the HDTV is a television standard for displaying a video in 1125 lines or 1260 lines, and it is used in current satellite digital broadcasting or ground wave digital broadcasting. An aspect ratio of a screen is at 4 width:3 height in SDTV and at 16 width:9 height in HDTV which is a ratio used by movies. The broadcast system of HDTV has two systems, that is, a 1080i system and a 720p system.

The watermarking screen size is a screen size of the to-be-watermarked image signal 100 in the digital watermarking apparatus. The detection screen size is a screen size of the watermarked image that the digital watermark detection apparatus assumes to be a to-be-detected image. More concretely, the detection screen size is a screen size of an image signal that a video player (television receiver) for playing back (or displaying) an image can deal with. If the video player corresponds to HDTV, the detection screen size is the HDTV size. If the video player corresponds to only SDTV, the detection screen size is the SDTV size.

The image signal reduced or enlarged by the scaling unit 11 is input to the specific frequency component extractor 12. The specific frequency component extractor 12 extracts a specific frequency component similar to that obtained at the time of detection of the digital watermark, for example, a comparatively high frequency component (step S12). The specific frequency component extractor 12 may use a filter of frequency domain, for example, a low pass filter or high pass filter having a give cutoff frequency, or a band pass filter having a given pass band center frequency. The filter used as the specific frequency component extractor 12 may use the same filter as that of the extractor (specific frequency component extractor) used for the digital watermark detector described hereinafter.

Describing about the specific frequency component, generally, the low frequency component influences a picture quality largely, whereas the high frequency component little influences the picture quality. For this reason, the picture quality deterioration can be reduced by embedding the digital watermark signal in a high frequency component.

Further, the low frequency component is not almost influenced by signal processing, but the high frequency component is largely influenced by the signal processing. For this reason, embedding of the digital watermark signal in the low frequency component can improve tolerance against an attack (various signal processing) to the digital watermark by embedding in a low frequency component. Therefore, the frequency band of the specific frequency component signal is determined according to the picture quality and attack tolerance requested for digital watermark. In other words, if the picture quality is important, the frequency band of the specific frequency component is set to a comparatively high frequency band. If the attack tolerance is important, the frequency band of the specific frequency component is set to a comparatively low frequency band.

Subsequently, the digital watermark signal generator 13 generates the digital watermark signal based on the specific frequency component signal output from the specific frequency component extractor 12 and to-be-watermarked watermark information 102 (step S13). The watermark information 102 is a signal stream of digital signals “1” and “0”, for example.

The digital watermark signal generated with the watermark signal generator 13 is enlarged or reduced with the second scaling unit 14 so that the difference between the screen size of the digital watermark signal and the screen size of the to-be-watermarked image signal 100 reduces or become zero (step S14). For example, if the watermarking screen size is the HDTV size, and the detection screen size is the SDTV size, the second scaling unit 14 enlarges the digital watermark signal from the SDTV size to the HDTV size.

The digital watermark signal enlarged or reduced with the second scaling unit is combined with the to-be-watermarked image signal 100 with the watermark signal compositor (step S15), resulting in generating an output image signal (referred to as a watermarked image signal) 103 in which watermark information is embedded. The watermark signal compositor 15 comprises a digital adder, for example.

The specific frequency component signals of a plurality of channels may be extracted with the specific frequency component extractor 12. In that case, the digital watermark signals of plural channels are enlarged or reduced by the second scaling unit 14, and then are combined with the to-be-watermarked image signal 100 with the watermark information compositor 15 to generate the watermarked image signal 103.

The watermarked image signal 103 in which a digital watermark signal is embedded in this way is recorded on a recording medium with a digital image record/playback apparatus such as a DVD system, shown in a movie theater as an opus, or transmitted through transmission mediums such as Internet, a broadcasting satellite, a communication satellite.

There will be described an operative example of the signal generator 13 using position setting/amplitude control referring to FIG. 2. The watermark information 101 is assumed to be formed of data of a plurality of bits (in this embodiment, N bits). According to the watermark signal generator 13 shown in FIG. 2, amplitude control/position setting units 16-1 to 16-N control the amplitude of the specific frequency component signal output from the specific frequency component extractor 12 according to values of respective bits, and set watermarking positions corresponding to respective bits of the watermark information 102 on the enlarged or reduced input image signal. The adder 17 adds the specific frequency component signals amplitude-controlled according to the values of the respective bits to the set watermarking positions to generate a digital watermark signal.

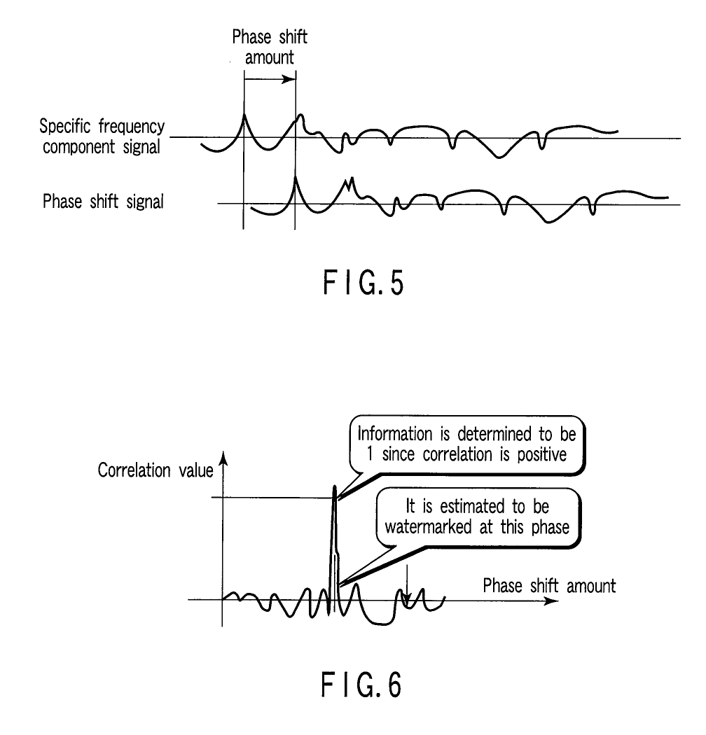

Concretely, the watermarking positions are set with a single digital phase shifter or a plurality of digital phase shifters. The watermarking position varies according to the phase shift amount of the phase shifter. FIG. 5 illustrates a state of the phase shift. In this example, the phase (position) of the specific frequency component signal is shifted simply with the waveform being kept. Concretely, the amplitude control is realized with a single or plural exclusive OR circuits or digital multipliers. The sign and magnitude of the amplitude at the time of amplitude control are controlled according to the activity representing the watermark information 102 or the complexity degree of image, and becomes a coefficient (embedment intensity) to be multiplied by an input specific frequency component signal. For example, the coefficient is set so that it increases as the activity increases. An operative example of phase setting and amplitude control is explained in detail hereinafter.

(As for the Digital Watermark Detection Apparatus)

There will be explained the digital watermark detection apparatus to detect the watermark information embedded as a watermark signal in an image signal from a watermarked image signal generated by the digital watermark embedding apparatus of FIG. 1.

To the digital watermark detection apparatus according to the present embodiment shown in FIG. 4 is input the watermarked signal 103 in which the watermark information 102 embedded with the digital watermark embedding apparatus of FIG. 1 via a recording medium or transmission medium. The information 102 is assumed to be a signal stream of “1s” or “0s” of a digital signal which is embedded in the image signal as described above.

The watermarked image signal 103 is input to the extractor 20 and the first orthogonal transformer 21A. The watermarked image signal 103 is subjected to orthogonal transform such as Fourier transform with the first orthogonal transformer 21B. A specific frequency component signal is extracted from the watermarked image signal 103 with the extractor 20. The extractor 20 uses a digital filter of the same frequency domain as that of the specific frequency component extractor 12 used for the digital watermark embedding apparatus of FIG. 1, for example, a low pass filter or high pass filter having a given cutoff frequency, or a band pass filter having a given pass band center frequency. The extractor 20 may extract a signal of all frequency components of the watermarked image signal 103. The specific frequency component signal extracted with the extractor 20 is subjected to orthogonal transform such as Fourier transform with another first orthogonal transformer 21B.

A component (for example, Fourier transformed component) via the first orthogonal transformer 21A and a component (for example, Fourier transformed component) via the first orthogonal transformer 21B are complex-combined with the compositor 22 to generate a composite signal. The composite signal is input to the amplitude compressor 23 whereby its amplitude component is compressed. In this way, the compressed signal is subjected to the orthogonal transform (inverse orthogonal transformation) such as inverse Fourier transform with the second orthogonal transformer 24. The second orthogonal transform must pair with the first orthogonal transformation. When the Fourier transform is used in the first orthogonal transform, the second orthogonal transform uses a Fourier transform or inverse Fourier transform. The signal subjected to the second orthogonal transform is input to an estimator 25 to estimate the watermark information 104.

The correlation technique based on the orthogonal transform, complex composition and amplitude compression is called phase-limited correlation. The positions at which the orthogonal transform, complex composition and amplitude compression are performed respectively may differ from those of FIG. 4. The correlation between the watermarked image signal 103 and the specific frequency component signal may use another correlation such as cross-correlation instead of phase-limited correlation.

There will be described a concrete method for estimating the information 104 with the estimator 25 referring to FIGS. 5 and 6.

The correlation (cross-correlation and phase-limited correlation) value of the watermarked image signal 103 (the image signal in which a phase-shifted/amplitude-converted signal of the specific frequency component signal is embedded) and the specific frequency component signal extracted with the extractor 20 is input to the estimator 25. FIG. 6 illustrates relation between this correlation value and the phase shift amount where the cross-correlation value is as the correlation value.

If the correlation value varies as shown in FIG. 6, a peak appears at a position of a certain phase shift amount. The polarity of this peak represents watermark information. For example, the peak of the cross-correlation value takes either a positive value or a negative value according to the value of the watermark information. If the peak is positive, the watermark information is determined to be “1” whereas if it is negative, the watermark information is determined to be “0”. In this way, the watermark information 104 that is determination result is output from the estimator 25.

The watermark detection apparatus of the present embodiment is suitable for a case that the image signal 103 suffers a scaling (enlargement/reduction) attack. When the watermarked image signal 103 suffers the scaling (enlargement/reduction) attack, the phase shift amount of the specific frequency component signal has a value different from the phase shift amount applied to the specific frequency component signal in the digital watermarking apparatus. For this reason, in the present embodiment, the phase shift amount is controlled continuously or stepwise with the estimator 25. The peak of correlation value output according to control of the phase shift amount is searched for, and the watermark information is estimated and detected based on the position and polarity or magnitude of the searched peak. In the example shown in FIG. 6B, since the correlation value is positive, the watermark information is estimated (determined) to be “1”. In this way, the watermark information 104 detected by the estimator 25 is output to the image suffered the scaling attack.

According to the present embodiment, the specific frequency component signal is extracted from the watermarked image signal 103, and the watermark information is detected based on the correlation result of correlation (cross-correlation and phase limited correlation) between this specific frequency component signal and the watermarked image signal 103. In this case, since the peak of correlation value can be searched for by performing correlation calculation while shifting the phase (changing the position), the watermark information 104 can be easily detected from the digital watermarked image suffered the scaling (enlargement/reduction) attack.

(A concrete Operation Example of the Digital Watermarking/Detection)

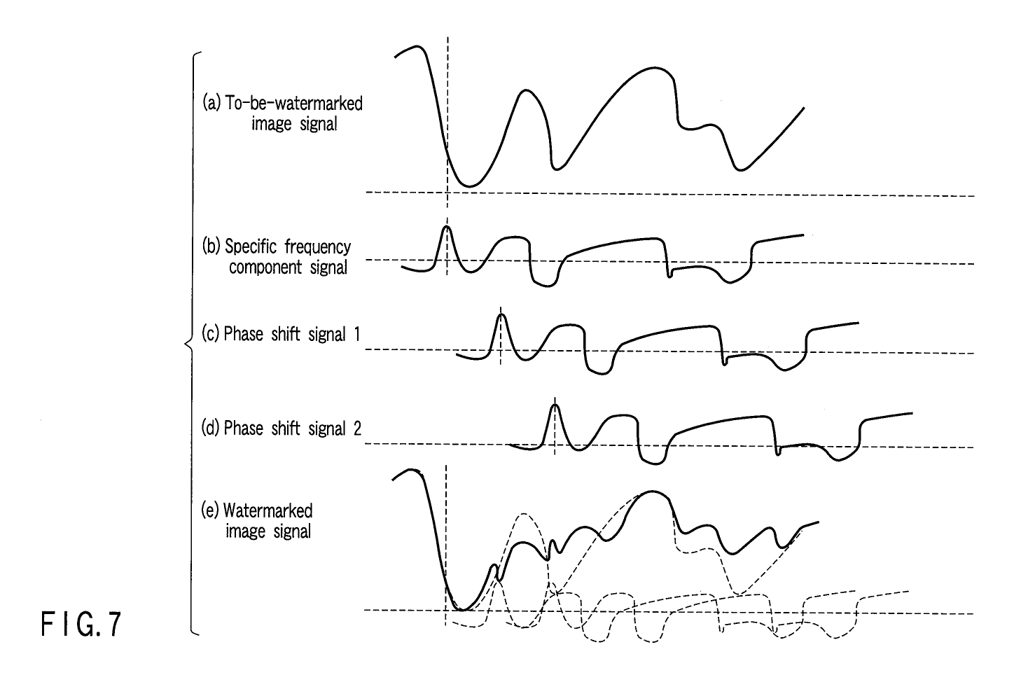

There will be described a concrete operation example of embedding the watermark information 102 of two bits in the image signal with the digital watermark embedding apparatus and detecting the watermark information with the digital watermark detection apparatus referring to FIGS. 7 to 10. For simplify the first and second scaling units 11 and 14 are assumed to perform scaling of 1 time, the description will be done with neglecting scaling. However, even if the scaling ratio, that is, enlargement/reduction ratio is not 1 time, the operation can be considered similarly to the above.

In the digital watermarking apparatus of FIG. 1, if the to-be-watermarked image signal 100 is assumed to be a signal shown at (a) in FIG. 7, a specific frequency component signal (corresponding to an image of a specific frequency component) shown at (b) in FIG. 7 is extracted from watermarked image signal 100 with the specific frequency component extractor 12 using a digital filter. This specific frequency component signal is input to the watermark signal generator 13 and phase-shifted by a given shift amount with two shifters.

The phase shift signal is multiplied by factors expressed by the 0-th bit and first bit of the information 102. For example, if the watermark information 102 is “0”, −1 is multiplied by the phase shift signal. If the information 102 is “1”, +1 is multiplied by the phase shift signal. The signals shown at (c) and (d) in FIG. 7 show phase shift signals 1 and 2 when the information 102 is (1,1), that is, the 0-th bit and the first bit are “1”. Since the phase of an image corresponds to a position in the image, the phase shift represents movement of a position in a screen. According to signals shown at (c) and (d) in FIG. 7, the specific frequency component signal differs in phase from the phase shift signals 1 and 2 due to the phase shift, particularly the positions of the peaks at the most left differ with each other. The difference between the positions of peaks of the signals occurs due to the phase shift.

Thereafter, the watermark information compositor 15 adds the to-be-watermarked image signal 100 to the phase shift signals 1 and 2 mortified by the factor for bit expression to generate the watermarked image signal 103 as shown at (a) in FIG. 7. The solid line shown at (e) in FIG. 7 represents the digital watermarked image 103, and the waveform shown at (e) in FIG. 7 is a waveform obtained by combining the to-be-watermarked image signal 100 and the phase shift signals 1 and 2 shown at (c) and (d) in FIG. 7.

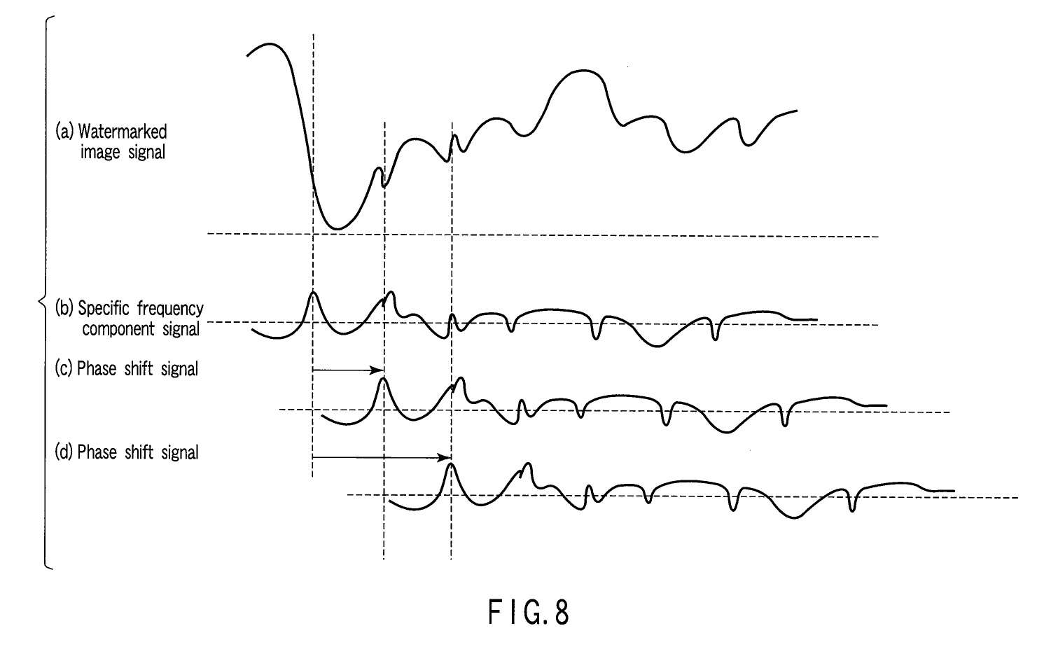

When the watermark detection apparatus of FIG. 4 detects the watermark information 102 from the watermarked image signal 103 in which the watermark information 102 is embedded, the extractor 20 such as a digital filter extracts the specific frequency component signal shown at (b) in FIG. 8 from the watermarked image signal 103 shown at (a) in FIG. 8 (corresponding to the watermarked image signal 103 shown at (e) in FIG. 7). When the watermarked image signal 103 suffers no scaling (enlargement/reduction) attack, the watermarked image signal 103 is phase-shifted by the same shift amount as the shift amount shown at (c) and (d) in FIG. 7 with the phase shifter as shown at (c) and (d) in FIG. 8.

The correlation value between the watermarked image signal 103 and the phase shift signal is obtained via the first orthogonal transformers 21A, 21B, compositor 22, amplitude compressor 23, second orthogonal transformer 24 and estimator 25. The watermark information is determined by the peak of the correlation value. For example, if the peak of the correlation value is positive, the watermark information is determined to be +1 (“1”), and if it is negative, the watermark information is determined to be −1 (“0”).

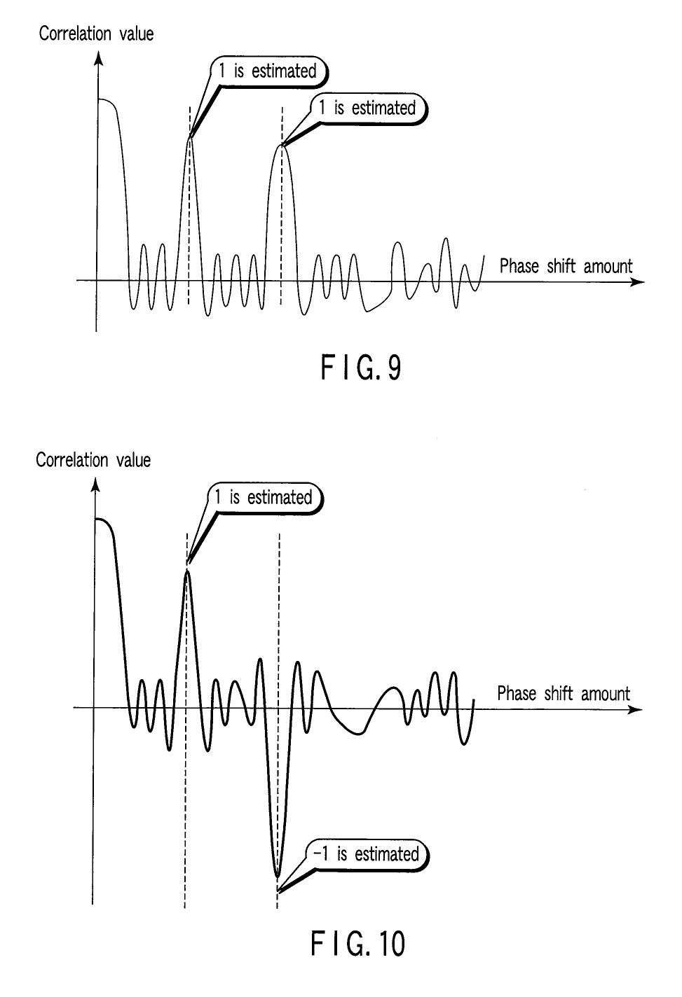

When the watermarked image signal 103 suffers the scaling (enlargement/reduction) attack, the phase shift amount is searched for by controlling the phase shift amount as explained referring to FIG. 6. In other words, the peak of the correlation value is searched for with the estimator 25 in accordance with control of the phase shift amount, and the watermark information 104 is estimated from the peak position. For example, when the embedded watermark information 102 is (1,1), the watermark information 102 is determined by two positive peaks of the correlation value aside from the origin (the phase shift amount is 0) as shown in FIG. 9. Further, when the case information 102 is (1,−1), the watermark information is determined by the positive peak of correlation that is near the origin and the negative peak that is far from the positive peak with respect to the origin as shown in FIG. 10. FIGS. 9 and 10 show cases using a cross-correlation value as the correlation value.

FIGS. 7 and 8 each show a signal of one line of an image in illustration, therefore the signal is depicted as one-dimensional signal. There is conceivable a system to reverse the polarity of the phase shift signal by any one of every line, every plural lines, every field, every plural fields, every frame and every plural frames or an appropriate combination of them when the specific frequency component signal is added to the to-be-watermarked image signal 100 to produce the watermarked image signal 103. Also, it is conceivable to provide a system of inversing the changing direction of the phase shift amount horizontally for every line.

Further, it is conceivable to provide a system of embedding a calibration signal together with a watermark signal in an image and utilizing the calibration signal for detection of the watermark information. Further, it is conceivable to provide a system of limiting the amplitude of the signal to suppress deterioration of picture quality when adding the specific frequency component signal 100 to the shift signals or a system of randomizing characteristics of at least one of the extractor and the phase amplitude changer.

Further, according to the present embodiment, in the digital watermark embedding apparatus, the first scaling unit 11 scales (enlarges or reduces) the to-be-watermarked image signal 100, and the second scaling unit scales (enlarges or reduces) the watermark signal. As a result, even if the watermarked image signal 103 suffers the big scaling attack, there is an advantage that detection performance of the digital watermark in a digital watermark detection apparatus is hard to deteriorate. The advantage of the embodiment will be described hereinafter.

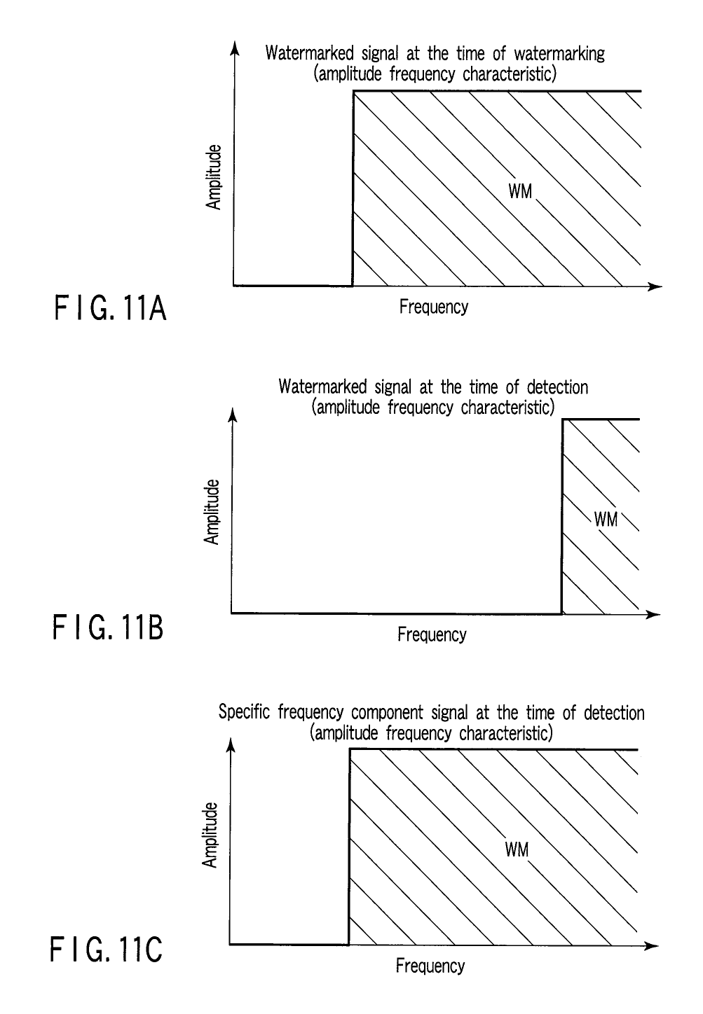

FIGS. 11 A, 11B and 11C each show an amplitude-frequency characteristic of the digital watermark signal (WM) for explaining an operation example of the digital watermarking/detection of the technique described in JP-A 2003-323736 (KOKAI). The digital watermark signal at the time of watermarking as shown in FIG. 11A uses a specific frequency component signal extracted from the to-be-watermarked image signal. It is assumed that the specific frequency component signal corresponding to the digital watermark signal of FIG. 11A is similar to the specific frequency component signal extracted from the watermarked image signal in the digital watermark detection apparatus.

It is assumed that the digital watermarking apparatus embeds in an image a digital watermark signal with a HDTV size, and the digital watermark detection apparatus detects the digital watermark signal with a SDTV size. In other words, it is assumed that the watermarking screen size is the HDTV size, and the detection screen size is the SDTV size. In other words, the watermarked image signal in which a digital watermark signal is embedded suffers a scaling attack for reduction from the HDTV size to the SDTV size, and then the embedded digital watermark is detected.

FIG. 11B shows an amplitude-frequency characteristic of a digital watermark signal at the time of detection in such a case. It is found from FIG. 11B that the digital watermark signal concentrates on a high frequency band side compared with FIG. 11A. This is due to the reason that the frequency component of the digital watermark signal shifts to the high frequency band side since the screen size of the watermarked image signal in which the digital watermark signal of FIG. 11A is embedded is changed (reduced) from the HDTV size to the SDTV size.

Subsequently, the digital watermark detection apparatus extracts a specific frequency component signal of the same frequency band as that of the watermark signal of FIG. 11A from the watermarked image signal as shown in FIG. 11C. In this case, since the embedded digital watermark signal concentrates on the high frequency band side as shown in FIG. 11B, the frequency band becomes narrower than that of the specific frequency component signal extracted with the digital watermark detection apparatus and shown in FIG. 11C. Accordingly, the energy of the extracted specific frequency component signal of FIG. 11C reduces with respect to the energy of the digital watermark signal at the time of watermarking as shown in FIG. 11A. As a result, detection performance of digital watermark is degraded due to the scaling (enlargement/reduction) attack.

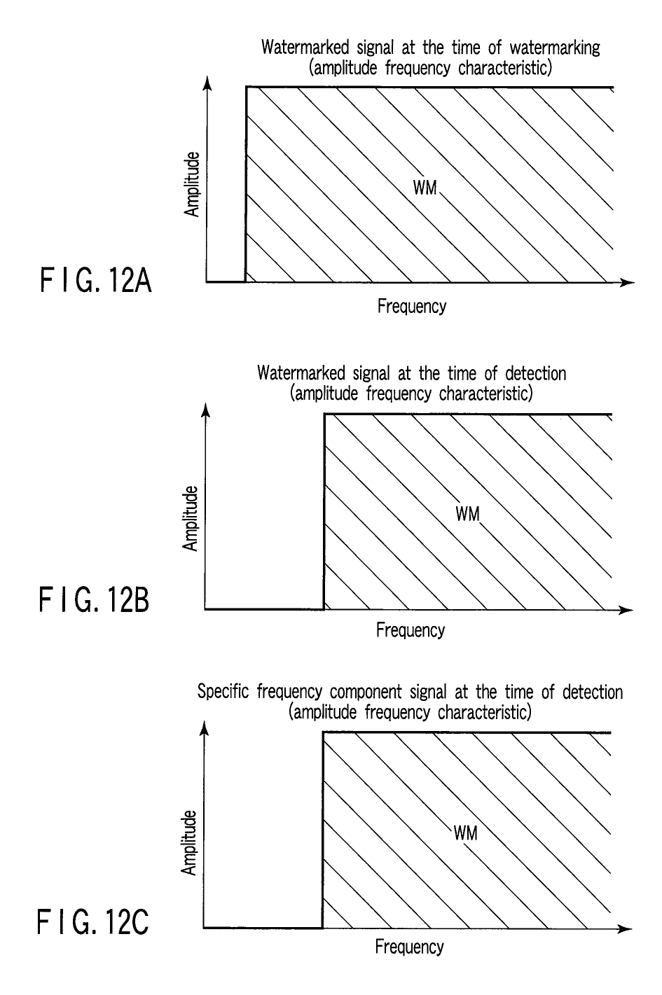

FIGS. 12A, 12B and 12C each illustrate an amplitude-frequency characteristic of the digital watermark signal (WM) for describing operation examples of the digital watermarking/detection apparatus according to the present invention. When the watermarked image signal 103 suffered a scaling attack and so on is input to the digital watermark detection apparatus, it is very difficult to specify the attack. Accordingly, it is difficult that the extractor 20 changes the frequency band from which it extracts a specific frequency component signal according to the attack that the watermarked image 103 suffered. For this reason, in the present embodiment, the digital watermark embedding apparatus changes the amplitude-frequency characteristic of the digital watermark signal according to an envisioned attack.

It is assumed that the digital watermarking apparatus of FIG. 1 embeds in an image a digital watermark signal at the HDTV size and the digital watermark detection apparatus of FIG. 4 detects the watermark signal at the SDTV size. In other words, the digital watermark detection apparatus detects the digital watermark signal after the watermarked image signal 103 in which a digital watermark signal is embedded with the digital watermarking apparatus received a scaling attack for reducing from the HDTV size to the SDTV size.

The digital watermark signal at the time of watermarking as shown in FIG. 12A is a signal produced from the to-be-watermarked image signal 100 through the first scaling unit 11, specific frequency component extractor 12, watermark signal generator 13 and second scaling unit 13. In other words, the to-be-watermarked image signal 100 is reduced from the HDTV size to the SDTV size with the first scaling unit 11, and the specific frequency component signal is extracted from the to-be-watermarked image signal size-reduced with the specific frequency component extractor 12. The digital watermark signal is generated from the extracted specific frequency component signal using information 102 with the signal generator 13. Further, the digital watermark signal of FIG. 12A is generated by enlarging the digital watermark signal from the SDTV size to the HDTV size with the second scaling unit 14. The frequency band of the digital watermark signal of FIG. 12A expands to the low frequency band with respect to the band of the digital watermark signal shown in FIG. 11A.

It is assumed that the frequency band of the digital watermark signal of FIG. 12A is similar to the frequency band of the specific frequency component signal extracted from the watermarked image signal 103 input to the digital watermark detection apparatus. In other words, the frequency band of the specific frequency component signal of the digital watermark signal of FIG. 12A is determined to be identical with the frequency band of the specific frequency component signal of FIG. 12C extracted with the extractor 20 when the digital watermark detection apparatus detects the watermark signal with the SDTV size.

On the other hand, the digital watermark detection apparatus detects the digital watermark signal as shown in FIGS. 12B and 12C. The component of the digital watermark signal of the watermarked image signal 103 input to the digital watermark detection apparatus is shown in FIG. 12B. By changing the digital watermark signal from the HDTV size to the SDTV size in screen size, the frequency band is shifted to the high frequency band side as shown in FIG. 12B when it is input to the digital watermark detection apparatus.

Subsequently, it is considered to extract an embedded digital watermark signal by extracting a specific frequency component signal from the watermarked image signal 103 in which the watermark signal of FIG. 12B is embedded, with the digital watermark detection apparatus as shown in FIG. 12C. The amplitude-frequency characteristic of the digital watermark signal at the detection time as shown in FIG. 12C is constant or identical with that of FIG. 11C notwithstanding the attack thereto. In this case, the energy of the digital watermark signal component capable of extracting with the digital watermark detection apparatus increases because the frequency band of the specific frequency component signal of FIG. 12C which is extracted with the extractor 20 resembles that of the digital watermark signal of FIG. 12B. Accordingly, even if the digital watermarked image signal suffers the scaling (enlargement/reduction) attack, detection performance of the digital watermark is not deteriorated.

In the embodiment, the watermarked screen size is the HDTV size, and detection screen size is the SDTV size. The present invention can be applied to a case that the watermarked screen size and the detection screen size differ to each other. The present invention can be applied to, for example, a case that the watermarked screen size is the SDTV size and the detection screen size is the HDTV size. In that case, the first scaling unit 11 has only to enlarge the screen size of the to-be-watermarked image signal 100 from the SDTV size to the HDTV size and the second scaling unit 13 has only to reduce the screen size of the digital watermark signal from the HDTV size to the SDTV size. Further, a case where the watermarked screen size is larger than the HDTV size (for example, a super-high vision (7,680*4,320 pixels) or 4 k digital cinema standard (4,096*2,160 pixels)), or a case where the detection screen size is the SDTV size are conceivable similarly to the above.

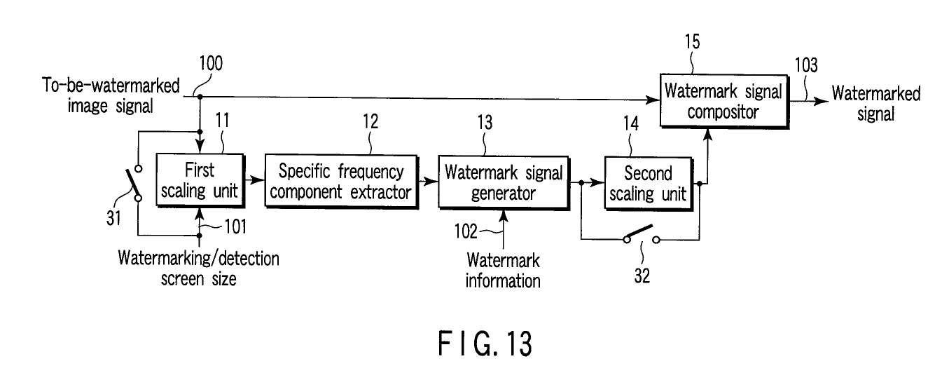

Further, as another embodiment, the digital watermarking apparatus shown in FIG. 1 may be configured to function as a digital watermarking apparatus having no first and second scaling units 11 and 12 when the watermarked screen size and the detection screen size are equal to each other. Concretely, for example, bypass switches 31 and 32 are connected to the first and second scaling units 11 and 13 as shown in FIG. 13. When the detection screen size differs from the watermarked screen size, the switches 31 and 32 are turned off, and when the watermarked screen size and the detection screen size are equal to each other, the bypass switches 31 and 32 are turned on to bypass the first and second scaling units 11 and 13.

The digital watermarking process and digital watermark detection process based on the above embodiments can be realized not only by hardware but also by software using a computer such as a personal computer.

The present invention is preferable to an apparatus to record and play back digital image data, for example, a digital VTR or DVD.

According to the present invention, high tolerance against a scaling attack making a screen size change greatly can be obtained and detection performance of digital watermark is improved. In other words, according to the present invention, the energy of the digital watermark signal component capable of being extracted with the watermark detection apparatus increases because the frequency band of the specific frequency component signal extracted in a digital watermark detection apparatus resembles that of the embedded digital watermark signal. Accordingly, even if the digital watermark watermarked image signal suffers a scaling (enlargement/reduction) attack, detection performance of digital watermark is not deteriorated.

Additional advantages and modifications will readily occur to those skilled in the art.

Therefore, the invention in its broader aspects is not limited to the specific details and representative embodiments shown and described herein.

Accordingly, various modifications may be made without departing from the spirit or scope of the general inventive concept as defined by the appended claims and their equivalents.

What is claimed is:

1. A digital watermark embedding method comprising:
scaling an input image signal to one of enlargement and reduction;
extracting a specific frequency component signal from the scaled image signal;
generating a digital watermark signal based on the specific frequency component signal and watermark information;
scaling the digital watermark signal to the other of the enlargement and reduction; and
combining the scaled digital watermark signal with the input image signal to generate a watermarked image signal.

2. The method according to claim 1, wherein the scaling the input image signal includes scaling the input image signal to make a difference between a screen size of the input image signal and a screen size of the watermarked image signal smaller than or equal to a threshold.

3. The method according to claim 1, wherein the scaling the digital watermark signal includes scaling the digital watermark signal to reduce or zero a difference between a screen size of the digital watermark signal and a screen size of the input image signal.

4. The method according to claim 1, wherein the extracting includes extracting a comparatively high frequency component of the scaled image signal as the specific frequency component signal.

5. The method according to claim 1, wherein the extracting includes extracting specific frequency component signals of a plurality of channels, and the scaling the digital watermark signal includes scaling the digital watermark signals of plural channels, and the combining includes combining the scaled digital watermark signals of plural channels with the input image signal.

6. The method according to claim 1, wherein the watermark information includes data of a plurality of bits, the generating includes setting a watermarking position corresponding to each of the plurality of bits to the scaled image signal, the combining includes setting at the watermarking position a signal obtained by controlling an amplitude of the specific frequency component signal according to a value of each bit.

7. The method according to claim 1, wherein the input image signal has a screen size of a high definition television system (HDTV), the scaling the input image signal includes reducing the input image signal to a screen size of a standard television system (SDTV), and the scaling the digital watermark signal includes enlarging the digital watermark signal to the screen size of the HDTV.

8. The method according to claim 1, wherein the input image signal has a screen size of a standard television system (SDTV), the scaling the input image signal includes enlarging the input image signal to a screen size of a high definition television system (HDTV), and the scaling the digital watermark signal includes reducing the digital watermark signal to the screen size of the SDTV.

9. A digital watermark embedding apparatus comprising:
a first scaling unit configured to scale an input image signal to one of enlargement and reduction;
an extraction unit configured to extract a specific frequency component signal from the scaled image signal;
a generator unit configured to generate a digital watermark signal based on the specific frequency component signal and watermark information;
a second scaling unit configured to scale the digital watermark signal to the other of the enlargement and reduction; and
a compositor unit configured to combine the scaled digital watermark signal with the input image signal to generate a watermarked image signal.

10. The apparatus according to claim 9, wherein the watermark information includes data of a plurality of bits, the generator unit sets a watermarking position corresponding to each of the plurality of bits to the scaled image signal, and the compositor unit sets at the watermarking position a signal obtained by controlling an amplitude of the specific frequency component signal according to a value of each bit.

11. The apparatus according to claim 9, wherein the input image signal has a screen size of a high definition television system (HDTV), the first scaling unit reduces the input image signal to a screen size of a standard television system (SDTV), and the second scaling unit enlarges the digital watermark signal to the screen size of the HDTV.

12. The apparatus according to claim 9, wherein the input image signal has a screen size of a standard television system (SDTV), the first scaling unit enlarges the input image signal to a screen size of a high definition television system (HDTV), and the second scaling unit reduces the digital watermark signal to the screen size of the SDTV.

13. The apparatus according to claim 9, wherein the first scaling unit scales the input image signal to make a difference between a screen size of the input image signal and a screen size of the watermarked image signal smaller than or equal to a threshold.

14. The apparatus according to claim 9, wherein the second scaling unit scales the digital watermark signal to reduce or zero a difference between a screen size of the digital watermark signal and a screen size of the input image signal.

15. The apparatus according to claim 9, wherein the extraction unit extracts a comparatively high frequency component of the scaled image signal as the specific frequency component signal.

16. The apparatus according to claim 9, wherein the extraction unit extracts specific frequency component signals of a plurality of channels, and the second scaling unit scales the digital watermark signals of plural channels, and the combining includes combining the scaled digital watermark signals of plural channels with the input image signal.

17. The apparatus according to claim 9, wherein the generator unit comprises a plurality of amplitude control/position setting units configured to control an amplitude of the specific frequency component signal according to values of bits of the watermark information, and set watermarking positions corresponding to the bits of the watermark information on the scaled input image signal, an adder to add the specific frequency component signals amplitude-controlled according to the values of the bits to the set watermarking positions to generate the digital watermark signal.

18. The apparatus according to claim 17, wherein the generator unit comprises a digital phase shifter to phase-shift the specific frequency component signal by a given phase shift amount to vary the watermarking position.

19. A computer readable storage medium storing instructions of a computer program which when executed by a computer results in performance of steps comprising:
scaling an input image signal to one of enlargement and reduction;
extracting a specific frequency component signal from the scaled image signal;
generating a digital watermark signal based on the specific frequency component signal and watermark information;
scaling the digital watermark signal to the other of the enlargement and reduction; and
combining the scaled digital watermark signal with the input image signal to generate an output image signal.

20. A digital watermark detection apparatus comprising:
an extractor to extract a specific frequency component signal from an watermarked image signal in which watermark information is embedded;
a first orthogonal transformer to subject the watermarked image signal to orthogonal transform to generate a first signal component;
a second orthogonal transformer to subject the specific frequency component signal to orthogonal transform to generate a second signal component;
a compositor to complex-combine the first signal component with the second signal component to generate a composite signal;
an amplitude compressor to compress an amplitude component of the composite signal to generate compressed signal;
a third orthogonal transformer to subject the compressed signal to orthogonal transform to generate a orthogonal-transformed signal; and
an estimator to estimate the watermark information from the orthogonal-transformed signal.
